(19) United States
(12) Patent Application Publication
(10) Pub. No.: US 2007/0191988 A1
(43) Pub. Date: Aug. 16, 2007

(54) APPARATUS AND METHODS OF USING CARD BASED PROGRAMMABLE CONTROLLERS

(76) Inventor: Peter S. Aronstam, Houston, TX (US)

Correspondence Address: PATTERSON & SHERIDAN, L.L.P., 3040 POST OAK BOULEVARD, SUITE 1500, HOUSTON, TX, 77056, US

(21) Appl. No.: 11/673,018

(22) Filed: Feb. 9, 2007

Related U.S. Application Data
(60) Provisional application No. 60/772,224, filed on Feb. 10, 2006.

(51) Int. Cl. G05D 23/00

(52) U.S. Cl. 700/276

(57) ABSTRACT

The present invention is generally directed to an apparatus and a method for controlling an environment control system. In one aspect, a programmable controller for operating an environmental control system is provided. The programmable controller includes a body and a controller member. The programmable controller also includes a sensor member configured to sense an environmental condition and send data to the controller member. Additionally, the programmable controller includes a removable memory card capable of storing and providing programmable data to the controller member, wherein the controller member, the sensor, and the removable memory card are disposed in the body. In another aspect, a method of using a programmable controller for operating an environmental control system is provided. In a further aspect, a method for managing an amount of energy units used by a user is provided.

### CROSS-REFERENCE TO RELATED APPLICATIONS

This application claims benefit of U.S. provisional patent application Ser. No. 60/772,224, filed Feb. 10, 2006, which is herein incorporated by reference.

### BACKGROUND OF THE INVENTION

1. Field of the Invention

Embodiments of the present invention generally relate to heating, ventilating, and air conditioning systems. More particularly, the invention relates to a card based environmental controller for use with heating, ventilating, and air-conditioning systems.

2. Description of the Related Art

The typical environmental control system, also commonly referred to as HVAC units, is operated by way of a single thermostat located in one of the rooms serviced by the environmental control system. The simplest of the controllers has a single set point and sends commands to the environmental control system to maintain that exact temperature on a continuous basis. In many instances, this is wasteful of energy resources as the temperature in a room need not be maintained when unoccupied. This problem has been partially addressed by the advent of programmable thermostat devices, which are capable of executing a time variant temperature control over the serviced room. As an example, one might raise the set point for an air-conditioning system in the home while the occupants are away at work and lower the set point an hour or so before their expected return, thus reducing energy consumption during the day.

Although these systems provide a means to accomplish improved energy utilization in the home, they are seldom used because the programming interface necessary to program the system is non-intuitive, generally a text based sequential screen process which has little tolerance for user error.

A further hindrance to proper utilization of these devices is the growing use of zone based HVAC delivery systems. These systems, whether hard wired or autonomous flow control units placed in the adjacent ductwork, are capable of a higher level of programming an optimization than can be easily programmed by a text based sequential screen data entry system.

A potential solution to this dilemma has been to install a processor based central controller, with a large graphical display in the home to oversee the environmental control system. However, this substantially increases the cost of an installation and still requires a moderately high level of computer literacy to program and operate the system.

### SUMMARY OF THE INVENTION

The present invention is generally directed to an apparatus and a method for controlling an environment control system. In one aspect, a programmable controller for operating an environmental control system is provided. The programmable controller includes a body and a controller member. The programmable controller also includes a sensor member configured to sense an environmental condition and send data to the controller member. Additionally, programmable controller includes a removable memory card capable of storing and providing programmable data to the controller member, wherein the controller member, the sensor, and the removable memory card are disposed in the body.

In another aspect, a method of using a programmable controller for operating an environmental control system is provided. The method includes positioning the programmable controller in a room, wherein the programmable controller comprises a body, a controller member, a sensor member, and a removable memory card. The method further includes removing the removable memory card from the body of the programmable controller. The method also includes programming the removable memory card and reinserting the removable memory card into the body of the programmable controller. Additionally, the method includes sending a control signal to the environmental control system based upon data generated from the sensor member and program data in the removable memory card.

In a further aspect, a method for managing an amount of energy units used by a user is provided. The method includes providing the user with a programmable controller for operating an environmental control system, wherein the programmable controller includes a removable memory card. The method also includes interviewing the user to determine user preferences. The method further includes removing the memory card and programming the memory card based upon user preferences. Furthermore, the method includes inserting the memory card into the programmable controller. Additionally, the method includes controlling the energy units used by the user by sending control signals from the programmable controller to the environmental control system based upon programmed data.

In yet a further aspect, a method of providing a pre-programmed memory card for use with a programmable controller in order to manage the amount of energy units used is provided. The method includes interviewing the user to determine user preferences and programming the memory card based upon user preferences. The method further includes delivering the memory card to the user and billing the user for the energy units used.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a diagrammatic view of the internal circuitry of a card based environmental controller;

FIG. 1a shows a view of typical packaging for the device illustrated in FIG. 1;

FIG. 2 shows an environmental control system utilizing the card based environmental controller.

FIG. 3 shows a programming station configured to prepare the memory card for a card based environmental controller;

FIG. 4 shows the card based environmental controller in an installation featuring remote wireless connected controllers;

FIG. 5 shows a facility with the card based environmental controller in communication with remote wireless connected controllers;

FIG. 6 shows a diagrammatic view illustrating a card based environmental controller with the additional capability of communicating to a wireless autonomous flow control unit in the room serviced by the card based environmental controller;

FIG. 6a shows a view of typical packaging for the device illustrated in FIG. 6;

FIG. 7 shows a view illustrating an installation of card based environmental controller in all rooms with capability of passing data to autonomous flow control units in addition to wireless coordination among the several controllers;

FIG. 8 shows a diagrammatic view illustrating a card based environmental controller with only the capability of communicating to a wireless autonomous flow control unit in the room serviced by the card based environmental controller;

FIG. 8a shows a view of typical packaging for the device illustrated in FIG. 8;

FIG. 9 shows a view illustrating an installation of card programmable systems in all rooms with capability of passing data to autonomous flow control units with a combined HVAC and room flow control unit controller in one room;

FIG. 10 shows a view illustrating an installation of card programmable systems in all rooms with capability of passing data to autonomous flow control units with a separate HVAC and room flow control unit controllers in one room;

FIG. 11 shows a flow chart of a method of providing programming service for a fee;

FIG. 12 shows a flow chart of a process flow which includes modeling of the users facility to optimize system performance;

FIG. 13 shows a flow chart of a process flow whereby an energy provider might provide program cards to a user based on a combination of user preferences and restrictions on energy budget;

FIG. 14 shows a flow chart of a process flow where an energy provider, working with the end user seeks to optimize efficiency but allows for increased rates for less efficient users;

FIG. 15 shows a flow chart of a process for optimizing comfort and minimizing consumption.

### DETAILED DESCRIPTION

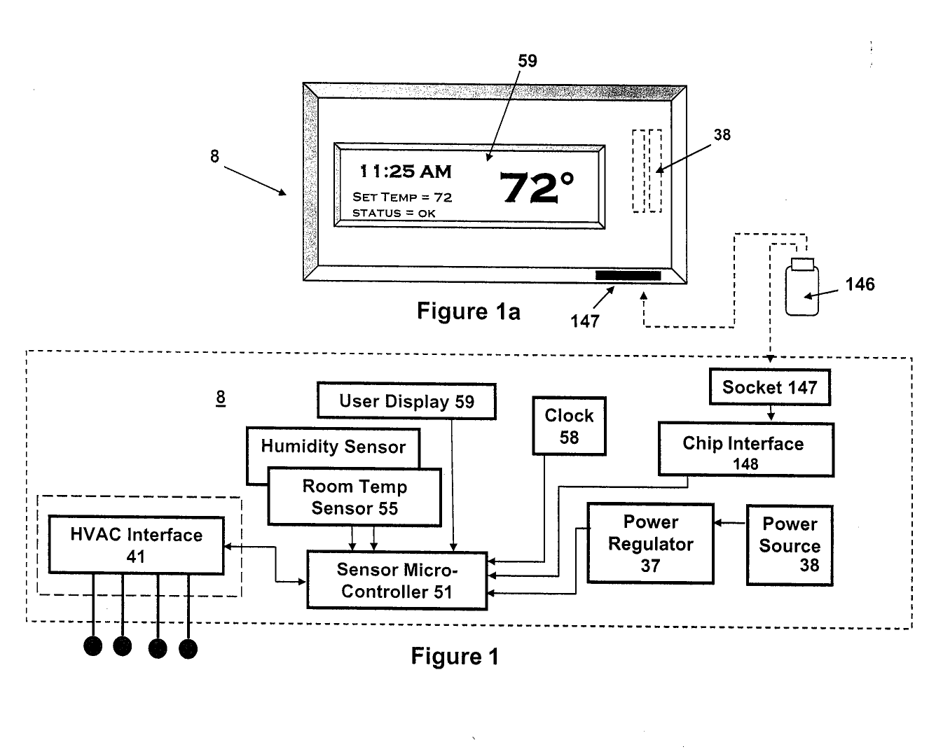

A card based environmental controller 8 provides the instructions for operating an environmental control system. In general when the room temperature rises above the set point in cooling mode, a card based environmental controller 8 turns the air-conditioner on. Conversely, when the temperature in the room falls below the set point in the heating mode, the device signals to turn on the heater mode. The set point may be a fixed value or may be a time variant value determined by the time of day or another variable. The difference in a card based environmental controller 8 is that the set points and time variant instructions are kept on a removable memory card 146 which is written or programmed remotely from the control unit. As shown in FIG. 1a, the card 146 is inserted in a slot 147 formed in a body or a support structure of the card based environmental controller 8. Instructions are read via the chip interface electronics 148 into the microcontroller 51. Program instructions in the microcontroller 51 compare the value detected by an environmental sensor 55 and the encoded user request on the memory card 146, wherein the environmental sensor 55 may be a thermal sensor and/or a humidity sensor. Depending on the comparison, the microcontroller 51 sends the appropriate signals to the environmental control unit via a HVAC interface 41. As an added feature, the microcontroller 51 may also relay data to the user via a user display 59. Additionally the microcontroller 51 may use a clock 58 to keep track of real time to allow for the interpretation of time variant instructions on the memory card 146. The sensor microcontroller 51 is powered by a power source 38 by way of a power regulator 37. The power source 38 may be any type of power source known in the industry, such as a battery, an induction member, or a wired source of power.

In addition to reading its instructions from the memory card 146, the microcontroller 51 may also write data to the memory card 146 using the same interface electronics 148. This would allow the passing of operational data back to the programming system and/or personnel in order to improve predictive models of performance and verify the compliance of the user in using the preprogrammed instructions. This chip might be returned periodically to an energy supplier or program vendor to allow such information to further optimize the use of the card based thermostat.

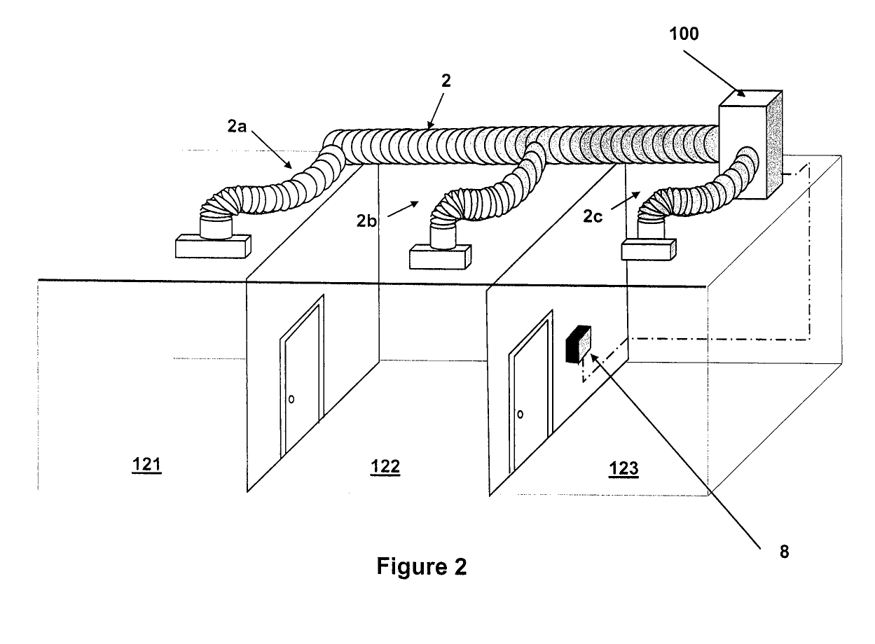

FIG. 2 shows a typical installation of the card based environmental controller 8 in a room 123 of a multi-room structure. In this example, the card based environmental controller 8 is hard wired to the environmental control unit 100, which supplies conditioned air to the structure through ductworks 2, although a wireless connection could also provide the connectivity.

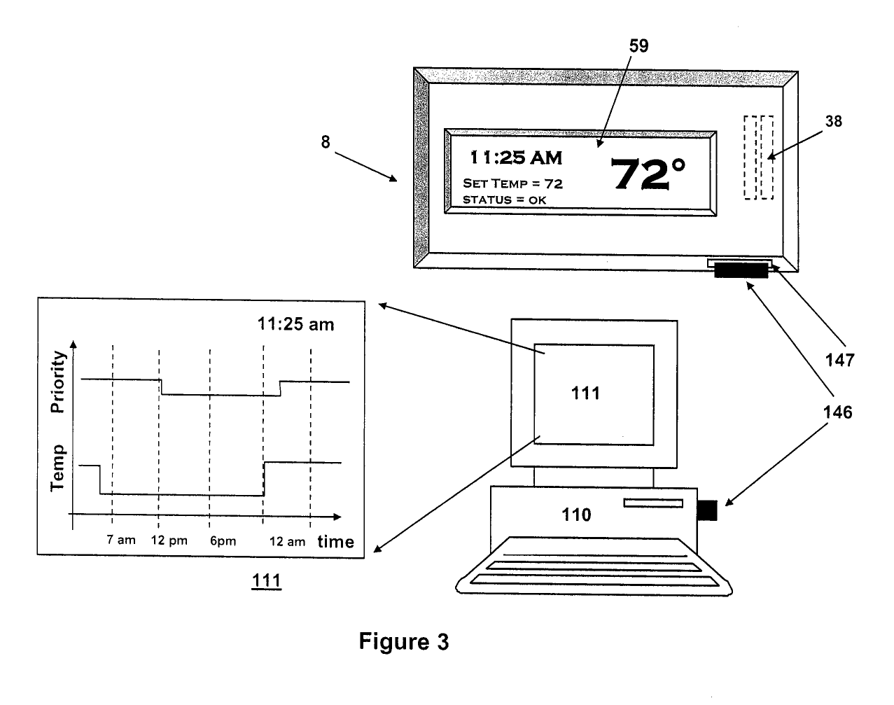

FIG. 3 shows the programming of the memory card 146 for use in a card based environmental controller 8. A user or service provider would enter commands via the input devices of a computer 110 representing the user's environmental preferences. As shown on the computer display 111, the sum of user environmental preferences may be a complex time based sequence with more than one variable depending on the nature of the system to be operated. Shown here is a two variable time map which might be used in a system containing autonomous flow control devices in addition to the environmental control unit. Although a desk top computer is illustrated, any computational device capable of reading and writing to removable cards could be used. Such devices could include PDA (personal digital assistants), calculators, purpose built programmers, and cell phones.

Although not illustrated in the figures, one would typically program several different scenarios into a single chip, which the user could then select with a single button. As an example, separate programs might be written for normal weekdays, weekends, vacation while in home, vacation while away, and entertainment to allow the optimal operation of the environmental control system under different user needs. In a similar manner, programs which take into account variation in solar influx and heat loss caused by the seasons into different programs resident on the memory card 146. Although these features require more interaction by the user, the nature of the interaction is substantially intuitive, one might just verbally say “summer vacation at home,” rather than going through a text based day by day, period by period programming exercise. In other words, the user may operate or control the card based environmental controller 8 by generating and transmitting a sound wave to the card based environmental controller 8.

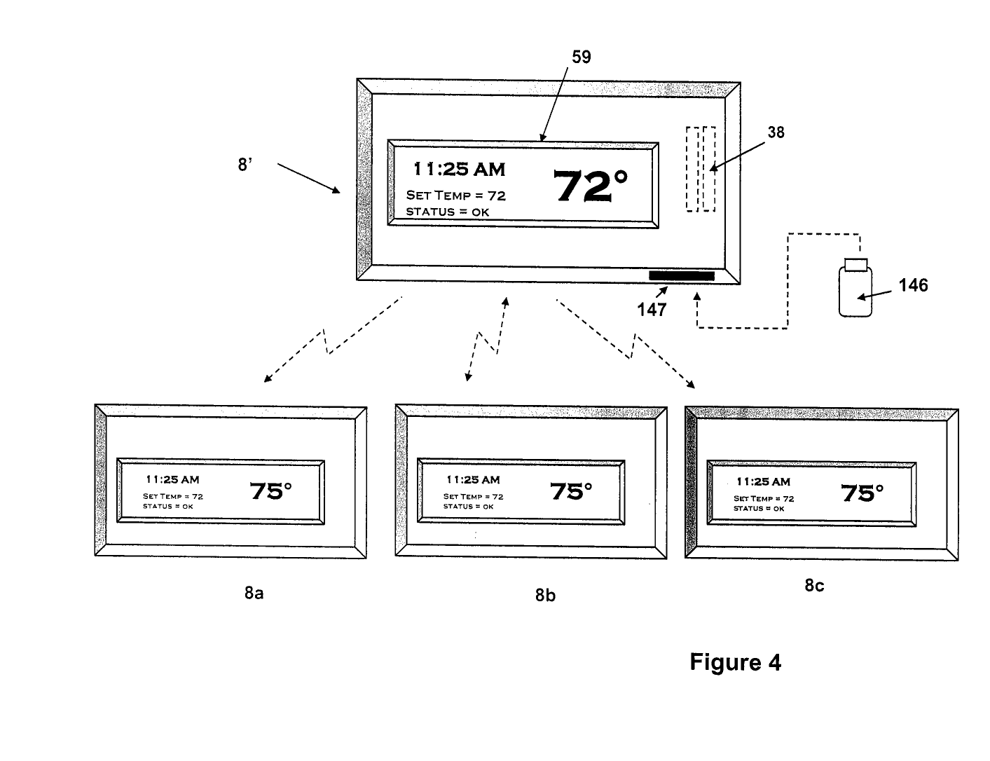

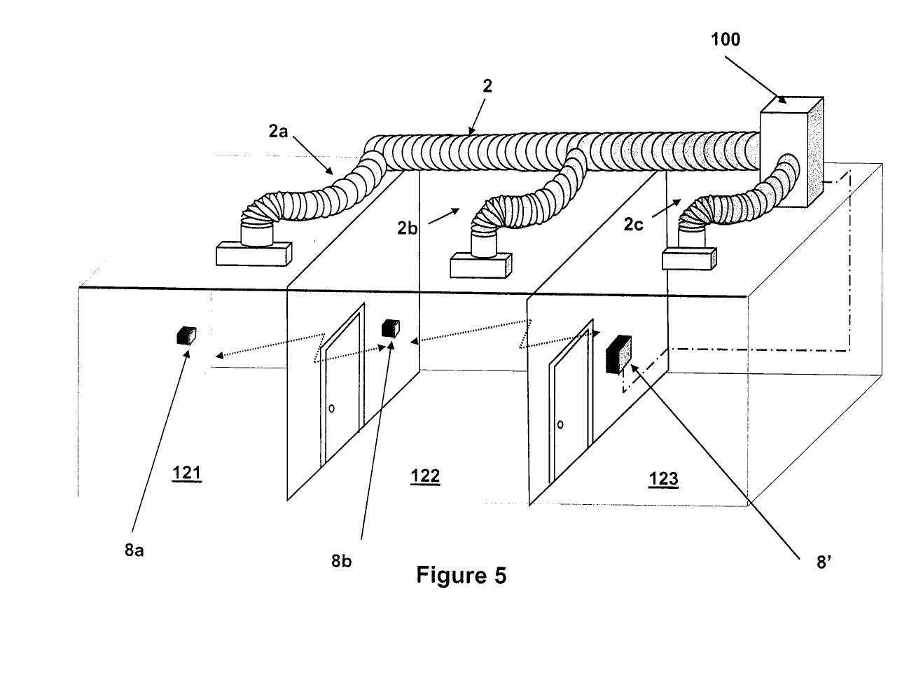

FIG. 4 shows an alternative embodiment where the card based environmental controller 8 is assisted in performing its function by a group of wireless thermostats 8a, 8b, 8c, which might be placed in other areas of the structure being serviced allowing the area to be serviced by zones. The instructions for the user's environmental preferences could be contained on a single card and relayed to the zone controllers as appropriate for the application or back to the thermostats themselves in a full duplex wireless system. FIG. 5 shows the physical layout for such a system. The master controller, with the card reader, is located in room 123 and the wireless devices are contained in rooms 121,122. In this configuration, one might have the temperature of the various rooms used at different times of the day to be the control set point for the master card based environmental controller 8, thus allowing for different room utilization or thermal influx due to sun exposure.

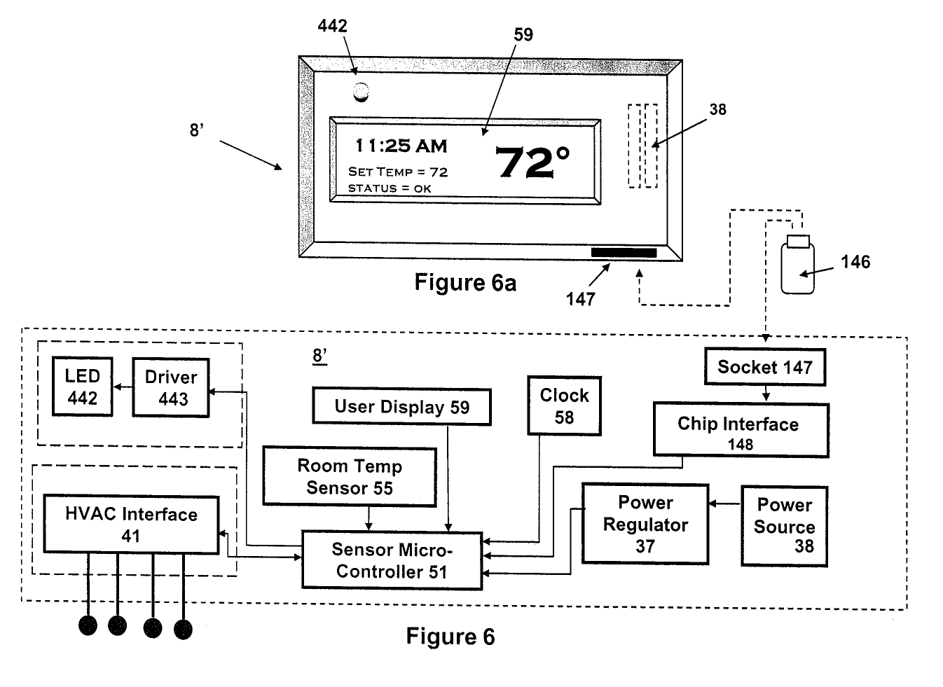

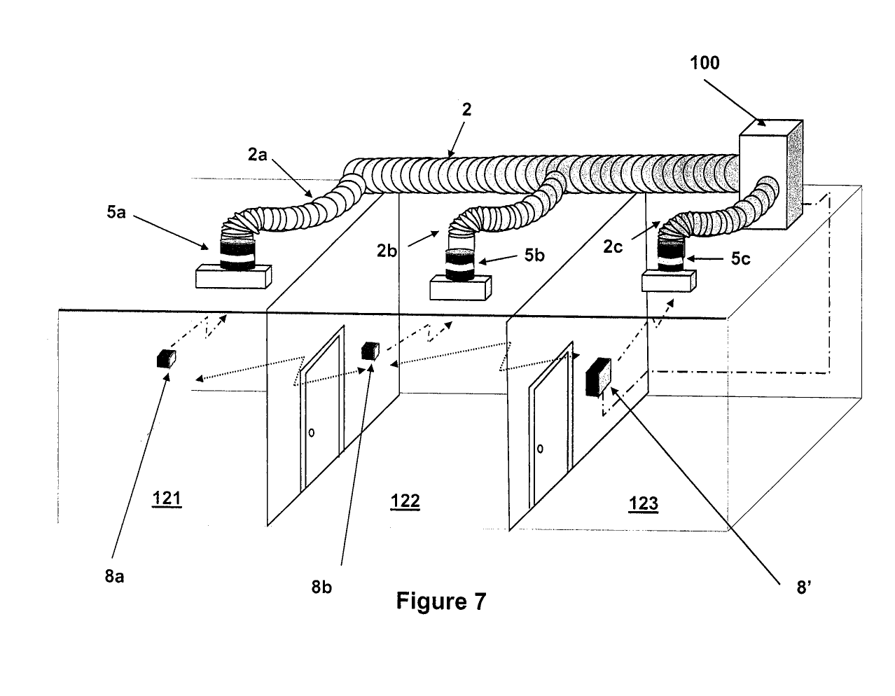

FIG. 6 shows an embodiment of the card based environmental controller 8, with the added feature of an IR communications port 442, 443, which allows the device to also control a remote autonomous flow control unit similar to that described in U.S. patent application Ser. No. 11/610,625, filed on Dec. 19, 2006, which is herein incorporated by reference. FIG. 7 shows the physical lay out for deploying such a device within a multi-room structure. The wireless thermostats 8a, 8b and the card based environmental controller 8 have the ability to control remote flow control devices 5a, 5b, 5c. An example of a flow control device is disclosed in U.S. patent application Ser. No. 10/987,476, filed on Nov. 12, 2004, which is herein incorporated by reference. Again in this example a single card in the card based environmental controller 8 provides all the operating instructions for all controllers.

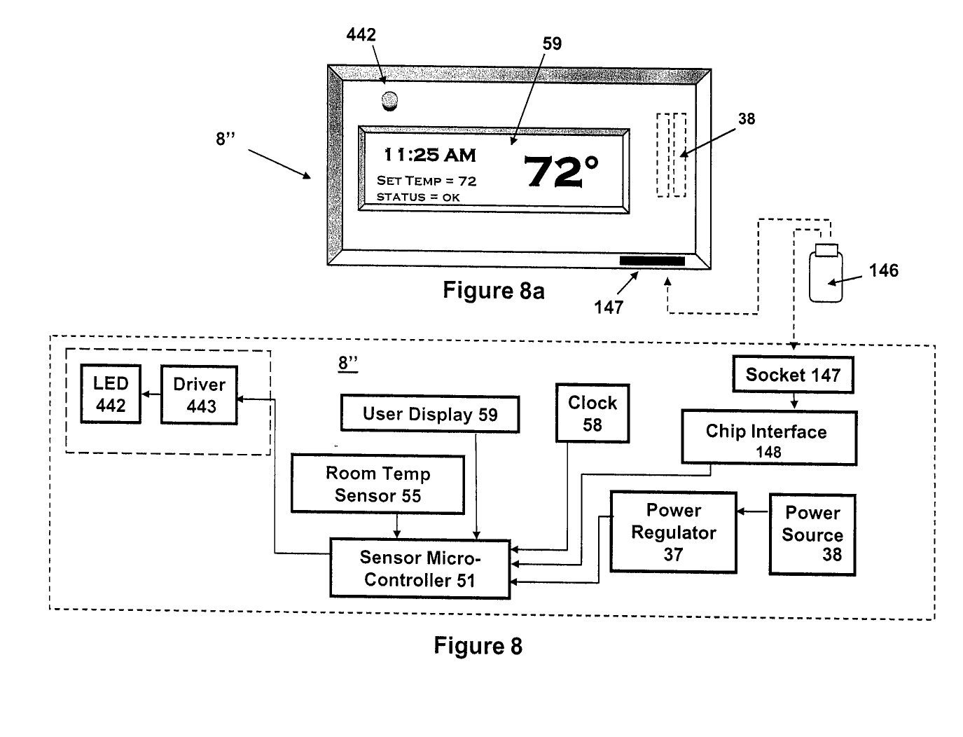

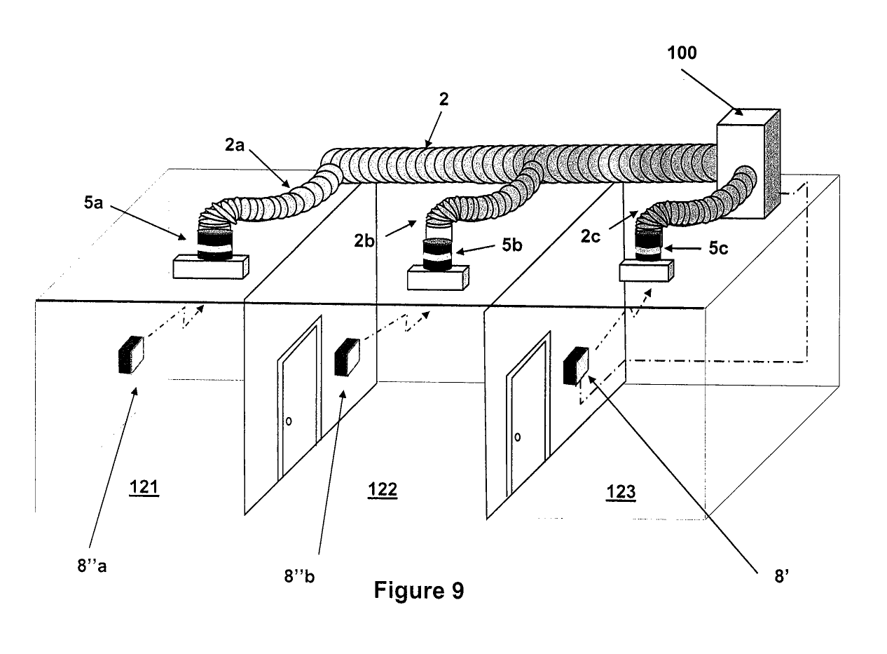

FIG. 8 illustrates the use of a card based system in a controller for a remote flow control unit as described in U.S. patent application Ser. No. 11/610,625. The sole method for connecting to the flow control device is via the led 442 and the driver 443 connected to the microcontroller 51. The application of such a control device is shown in FIG. 9. Here the environmental control system controlled by a card based environmental controller 8′ and the other rooms 121, 122 are controlled by card based environmental controllers 8″a, 8″b. In this example, each room may act as a separate zone, and each then would be able to make use of the full time variant programming available in the card based controller solution.

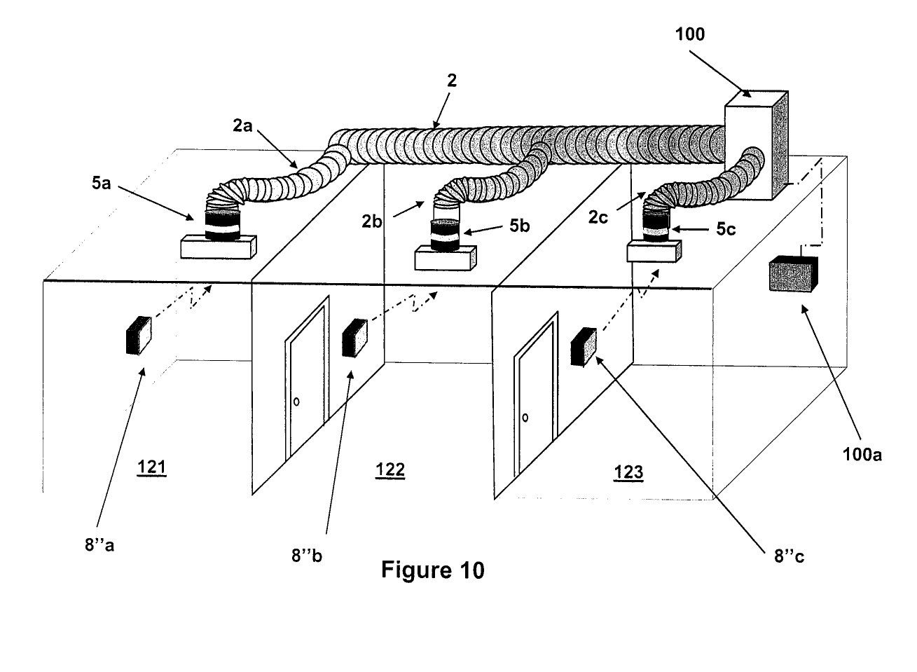

In an alternate method of application, as shown in FIG. 10, each room has a separate card based environmental controller 8″a, 8″b, 8″c and the environmental control unit 100 is managed separately using a conventional system controller 100a. Here the zone controlling card based environmental controllers 8″a, 8″b, 8″c seek to balance the air flow independently of the environmental control unit.

Referring back to FIG. 4, the memory cards used to instruct a card based environmental controller 8 are programmed by use of a computer 110 or similar device. The operator, using the input devices of the computer 110, programs the desired end user environmental preferences in either a tabular, text, or graphical means. Shown here is a graphical means on the computer display 111. The user environmental preferences may be a complex series of time variant parameters such as temperature, humidity, or priority for a specific room. Such priority might signify room utilization or be guidelines for the system to gracefully fail in reaching the primary goals requested dropping certain rooms or preferences. Such occurrences are common in high temperature environments where the installed air capacity is insufficient to lower an entire facility below a certain temperature.

A primary reason that programmable thermostats are not used is the difficulty in programming older text based menu systems and a general unfamiliarity with setting these devices by the general public. The existence of card based environmental controllers opens the door to a business which could provide the programming on demand, alleviating the need for end user programming using a variety of methods and rewards. For instance, a governmental entity or a business entity, such as an energy provider or equipment manufacturer, could provide the programming of the memory card 146 for a fee or for no fee depending on the overall objective.

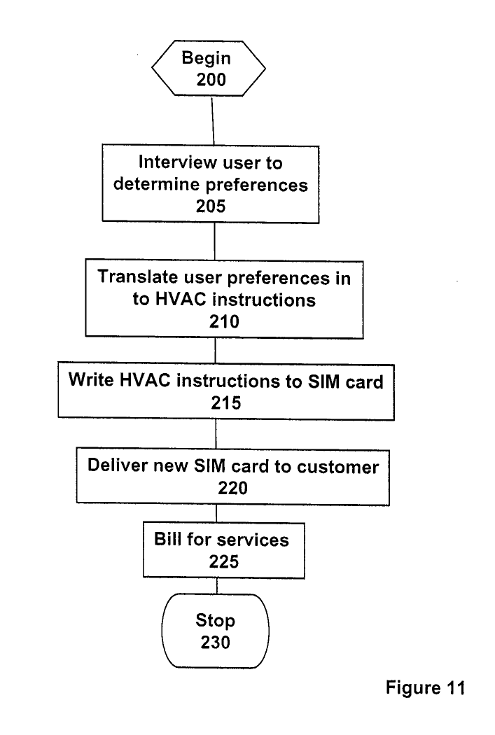

FIG. 11 shows a flow chart of a method of providing a programming service for a fee. The method begins when a business representative interviews the end user to determine the optimal set of user preferences based on their personal desires and perhaps some knowledge of the capabilities of their system, steps 200, 205. This interview could be in person, conducted by phone, presented as a survey form to be filled out and returned, or a web based application which the end user reaches over the World Wide Web. After ascertaining the user's preferences and other relevant parameters, the business representative would translate the preferences into a form suitable for programming in the memory chip, steps 210, 215. Once translated, the instructions could be physically programmed into the memory chip and possibly verified by simulation on the programming computer. Once programmed and verified, the chip is delivered to the end user for installation in the user's card based environmental controller, step 220. This delivery could be by mail, courier, company representative, or downloaded via the World Wide Web to a memory chip writer in a home-based computational device. On delivery of the chip, the end user would remunerate the business for the service rendered, steps 225, 230. This might take the form of an invoice, a credit card charge, Paypal®, or other common method of payment. This process then would be repeated whenever there was a change in user status (a spouse starts working and not home in daytime) or seasonally to account for the variation in load due to external temperature and weather. In one embodiment, an automated web based system is created to allow the user to program the memory card via the World Wide Web. In another embodiment, a software licensing arrangement is set up to allow the user to program the memory card in a home-based computational device.

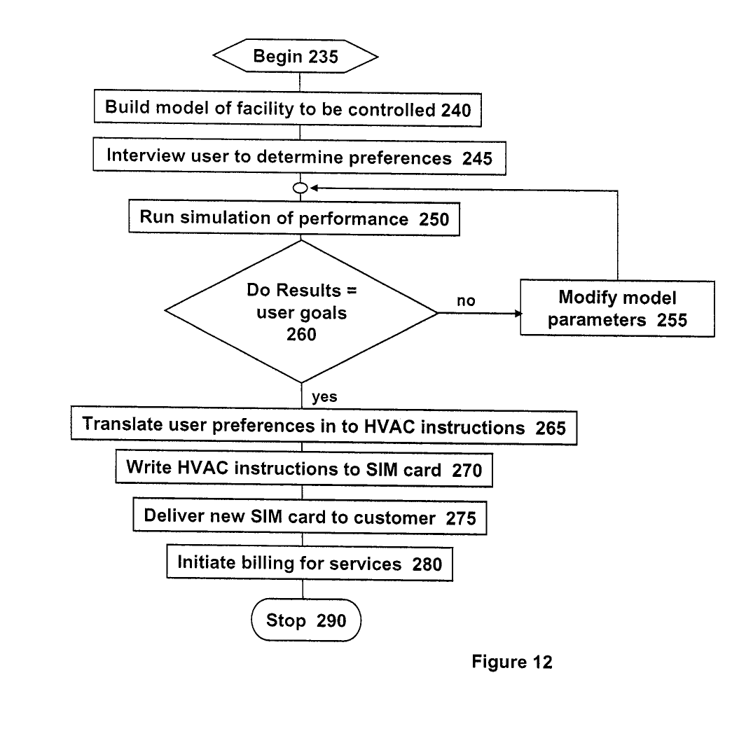

FIG. 12 shows a flow chart of a process flow which includes modeling of the users facility to optimize system performance. One of the key issues in environmental management of buildings is the understanding of how the building operates and responds to various influxes and controls. The method of FIG. 12 begins by creating a model of the structure to be controlled, steps 235, 240. This model may be as simple as a spreadsheet table using square footage to a full blown three-dimensional air flow model using high end computational methods. Once this model is created, the business representative proceeds to interview the end user (or users) to determine their preferences, step 245. Given these preferences, the business representative may run a simulation of the facility to determine the necessary control parameters to meet the user's preferences, steps 250, 255, 260. In complex structures often changing the air flow to one zone or room will adversely affect the performance in another area. For this reason, it will probably be necessary to modify the control settings and repeat the simulation until an appropriate set of operation parameters can be determined. Once found, these can be translated into instructions for the card based environmental controller and programmed as before, steps 265, 270, 275. Finally, the end user would be billed for the services completing the business cycle, steps 280, 290.

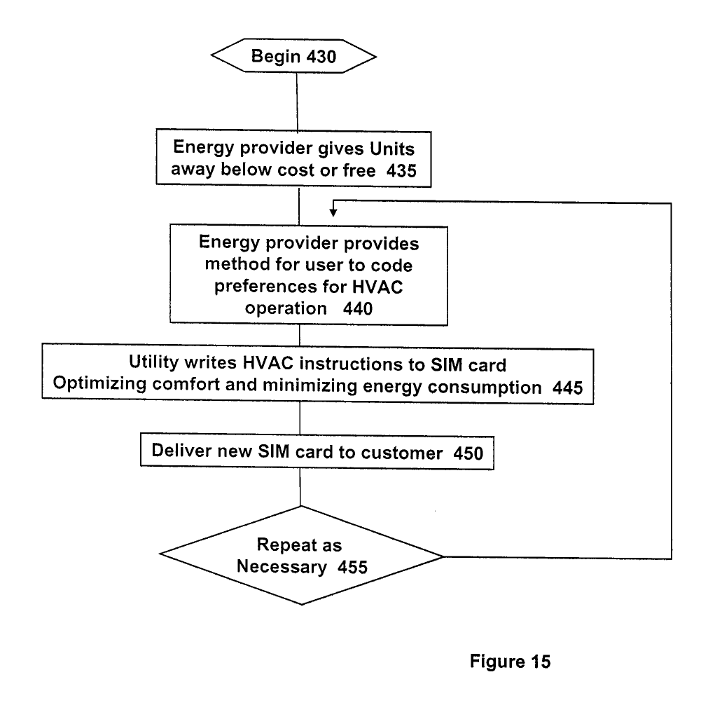

To this point in the discussion, the methods have all resolved around being paid to provide the service of programming user preferences into cards for card based environmental controllers. There are, however, other methods of value creation which businesses might employ using these devices. One can envision several methods whereby an energy provider and a programming service might use these devices to encourage conservation. According to industry experts, the appropriate setting of time based air-conditioning and zoning could save up to 25% of an end user's electrical consumption over existing single controller, single temperature systems. With increasing population and the corresponding growth in energy usage, utility providers are fighting a battle to build new power facilities fast enough to meet the demand. If on average 50% of an individual's energy usage is for environmental control (typical in the Sun Belt), then the wide spread use of card based environmental controllers would allow an equal percentage of growth in population, without additional energy capacity being needed. With new power stations costing in the billions of dollars, a utility provider could give the devices away for free or at minimal cost, provide the programming, and still improve their bottom line by reduced capital and operating expenses of new facilities. Such a process is illustrated in FIG. 15. A more likely scenario would be a partnership between the user and the utility provider where the use and adherence to agreed programming might be used to set or differentiate rates for energy.

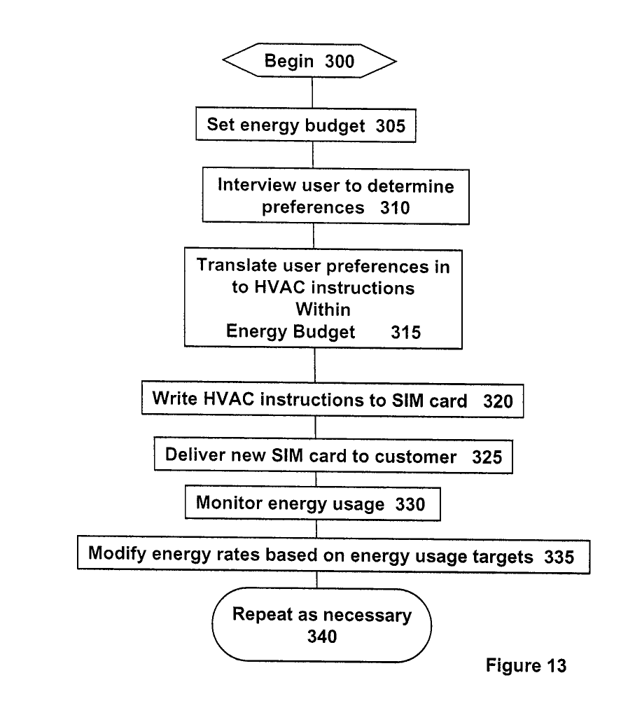

FIG. 13 illustrates a flow chart of a process flow where an energy provider provides the memory cards to a user based on a combination of user preferences and restrictions on energy budget. The process starts with a proposed energy budget, steps 300, 305. After an interview with the end user for preferences, the business representative creates a series of instructions for the environmental control unit which will maintain operations within the proposed budget, steps 310, 315, 320. After delivery to the client, the utility provider monitors the user's energy usage to verify operating within expected budget and, if so, might set the rates more favorably than if the user continues to over consume, steps 325, 330, 335, 340.

It is also possible that the utility provider or energy supplier might request the return of the previously used programming card to extract such operating history as might be necessary to improve the modeling of performance and to assist in verifying how the device was ultimately used by the end user.

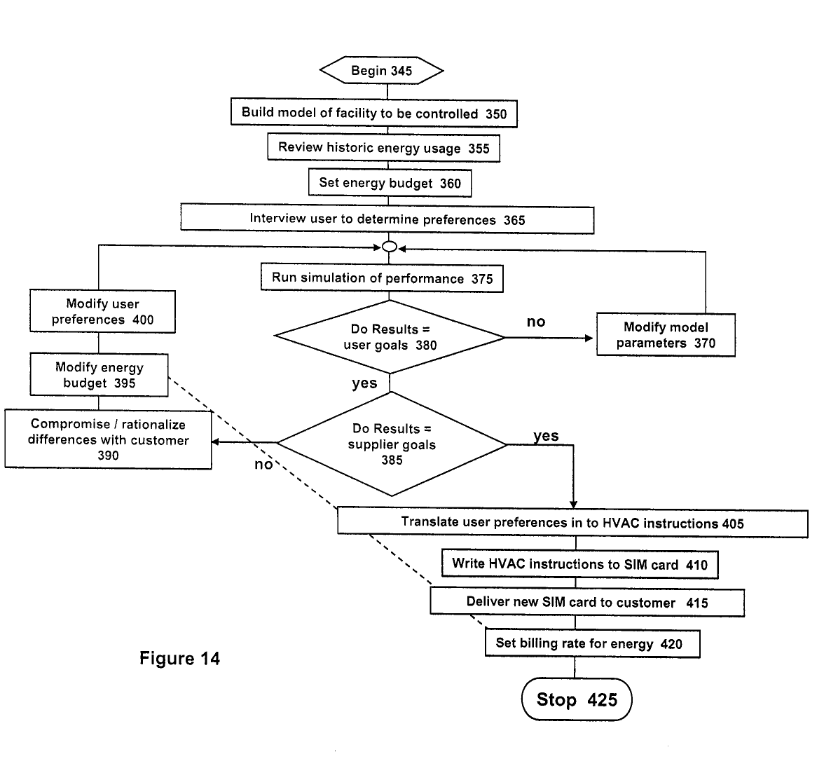

Another process flow chart is illustrated in FIG. 14. Here to improve the accuracy of simulation and prediction of energy usage, a model of the structure is built and ran to optimize the user's preferences and also the utility provider's goals in energy usage. For example, the process starts with building a model of a facility to be controlled, reviewing the historic energy usage, and setting an energy budget, steps 345, 350, 355, 360. Thereafter, the process includes interviewing the user to determine preferences, running a simulation of performance, determining results, and modifying model parameters, if necessary, steps 365, 370, 375, 380. The process further includes determining if the results of the simulation meet the goals of the supplier, compromising the differences with the customer, modifying the energy budget, and modifying the user's preferences, if necessary, steps 385, 390, 395, 400. The process also includes translating the user's preferences into HVAC instructions, writing HVAC instructions to the removable memory card (or SIM card), delivering a new removable memory card to the user, and setting a billing rate for the energy, steps 405, 410, 415, 420, 425. As stated, this process may involve the step of discussions/negotiations with the user, which could be linked to the final rate for energy depending on the user's preferences relative to the average user's preferences.

FIG. 15 illustrates a flow chart of a process for optimizing comfort and minimizing consumption. The process starts by the energy provider giving units to the user for free or below cost, steps 430, 435. The process also includes the energy provider providing a method for the user to code the preferences for HVAC operation and writing HVAC instructions to a removable memory card to optimize comfort and minimize energy consumption, steps 440, 445. Further, the process includes delivering the removable memory card to the customer and repeating the process if necessary, steps 450, 455.

While the foregoing is directed to embodiments of the present invention, other and further embodiments of the invention may be devised without departing from the basic scope thereof, and the scope thereof is determined by the claims that follow.

1. A programmable controller for operating an environmental control system, the apparatus comprising:
a body;
a controller member;
a sensor member configured to sense an environmental condition and send data to the controller member; and
a removable memory card capable of storing and providing programmable data to the controller member, wherein the controller member, the sensor, and the removable memory card are disposed in the body.

2. The apparatus of claim 1, further including a display member disposed in the body, wherein the display member is configured to display data to a user.

3. The apparatus of claim 1, further including a communication member configured to transmit control data generated by the controller member to at least one other programmable controller.

4. The apparatus of claim 1, further including a clock member for providing real time data to the controller member.

5. The apparatus of claim 1, wherein the sensor member is a thermal sensor, a humidity sensor, a proximity sensor, or combinations thereof.

6. The apparatus of claim 1, further comprising a communication member configured to send signals generated by the controller member to the environmental control system, a flow control unit, or combinations thereof.

7. The apparatus of claim 1, further including a power source configured to supply power to the controller member and the sensor.

8. The apparatus of claim 7, wherein the power source is a battery, an induction member, or a wired source of power.

9. The apparatus of claim 1, wherein the memory card is configured to be programmed by a computer, a personal digital assistant, a cell phone, or combinations thereof.

10. A method of using a programmable controller for operating an environmental control system, the method comprising:
positioning the programmable controller in a room, the programmable controller comprising a body, a controller member, a sensor member, and a removable memory card;
removing the removable memory card from the body of the programmable controller;
programming the removable memory card and reinserting the removable memory card into the body of the programmable controller; and
sending a control signal to the environmental control system based upon data generated from the sensor member and program data in the removable memory card.

11. The method of claim 10, wherein the memory card is configured to be programmed by a computer, a personal digital assistant, a cell phone, or combinations thereof.

12. The method of claim 10, further including sensing an environmental condition in the room.

13. The method of claim 12, wherein the environmental condition is temperature, pressure, humidity, or combinations thereof.

14. The method of claim 12, further including displaying data relating to the environmental condition on a display member in the body of the programmable controller.

15. A method for managing an amount of energy units used by a user, the method comprising:
providing the user with a programmable controller for operating an environmental control system, wherein the programmable controller includes a removable memory card;
interviewing the user to determine user preferences;
removing the memory card and programming the memory card based upon user preferences;
inserting the memory card into the programmable controller; and
controlling the energy units used by the user by sending control signals from the programmable controller to the environmental control system based upon programmed data.

16. The method of claim 15, wherein the step of interviewing the user is provided via a web based program.

17. The method of claim 15, wherein the user inserts the memory card into the programmable controller.

18. The method of claim 15, further including building a model of a facility employing the environmental control system.

19. The method of claim 18, wherein the model is used for simulating the performance of user preferences.

20. The method of claim 18, wherein the model is used for simulating energy usage under different scenarios.

21. The method of claim 15, further including monitoring the energy units used.

22. The method of claim 21, further including sending the user a revised memory card based upon data generated while monitoring the energy units used.

23. The method of claim 15, further including generating data by simulating the performance of user preferences.

24. The method of claim 23, further including comparing the data generated by the simulated performance to an energy budget.

25. The method of claim 24, further including reprogramming the memory card based upon the comparison of data.

26. The method of claim 15, wherein the user is charged a fee for programming the memory card.

27. The method of claim 15, wherein an energy provider provides the programming of the memory card in order to manage the amount of energy units used by the user.

28. The method of claim 27, wherein the energy provider programs the memory card based upon a set billing rate.

29. The method of claim 27, wherein the energy provider provides the programming of the memory card at or below cost or at no cost to the user.

30. The method of claim 15, wherein a governmental entity provides the programming of the memory card in order to manage the amount of energy units used by the user.

31. The method of claim 15, wherein an equipment manufacturer provides the programming of the memory card in order to manage the amount of energy units used by the user.

32. The method of claim 31, wherein the equipment manufacturer programs the memory card based upon a sales contract or a maintenance contract.

33. The method of claim 15, further including providing an automated web based system to allow the user to program the memory card.

34. The method of claim 33, wherein the user is charged a fee for programming the memory card.

35. The method of claim 15, further including providing a pre-programmed memory card based upon each season of the year.

36. A method of providing a pre-programmed memory card for use with a programmable controller in order to manage the amount of energy units used, the method comprising:
interviewing the user to determine user preferences;
programming the memory card based upon user preferences;
delivering the memory card to the user; and
billing the user for the energy units used.
